(19) United States
(12) Patent Application Publication
(10) Pub. No.: US 2014/0258403 A1
(43) Pub. Date: Sep. 11, 2014

(54) SERVICE TRACKING DISPLAY GRID SYSTEM AND METHOD

(71) Applicants: Lee Elmore, Naples, FL (US); Felix Lluberes, Naples, FL (US); Hong Long, Naples, FL (US)

(72) Inventors: Lee Elmore, Naples, FL (US); Felix Lluberes, Naples, FL (US); Hong Long, Naples, FL (US)

(21) Appl. No.: 13/792,272

(22) Filed: Mar. 11, 2013

(51) Int. Cl. H04L 29/06

(52) U.S. Cl. CPC H04L 65/403
USPC 709/204

(57) ABSTRACT

Systems and methods providing real time services to users of associated kiosk device terminals in the form of service tracking and display functionality. Embodiments of the invention allow a user to become associated with a group of other users via user kiosk devices that allow data and information to be readily shared in real time in accordance with each user's requirements. A computer-based service hosting platform provides a constellation engine that associates user kiosk devices with services provided in the form of software-based service nodes and allows the service nodes and the user kiosk devices to communicate directly over a transport layer implemented, at least in part, using full-duplex communication channels over a single transmission control protocol (TCP) connection.

### BACKGROUND

1. Technical Field

The subject matter disclosed herein relates to providing services via computer-based and communication-based technologies. In particular, the subject matter disclosed herein relates to a service tracking display grid system and method providing service nodes for providing real time services to users of associated kiosk device terminals.

2. Discussion of Art

Today, complex networks are often employed to allow multiple user devices at various locations to communicate with each other in an associated manner. Video conferencing is one example of such complex networks. Depending on the network, it can be quite cumbersome for a user to join a communication session to become associated with other users of that communication session. Furthermore, it may be difficult and cumbersome for users to share data and information with each other during the communication session, depending on the network and the type of data and information to be shared. Therefore, it is desirable to provide a system and method that simplifies the process of a user becoming associated with another group of users via user devices and that allows data and information to be easily shared in real time, based on each user's requirements.

### BRIEF DESCRIPTION

In one embodiment, a computer-based service hosting platform is provided that includes a constellation engine configured to provide software-based service nodes, that provide one or more services, to operate on the constellation engine and which are accessible by external user kiosk devices. The constellation engine is also configured to route information directly between the service nodes over a transport layer of the constellation engine. The computer-based service hosting platform also provides a database service node configured to operate on the constellation engine to retrieve information from at least one database computer when the information changes in the at least one database computer. The computer-based service hosting platform also provides at least one data cache (data bucket) associated with at least one service node and is configured to store updated information derived from one or more of the at least one database computer via the database service node or external user kiosk devices. The service nodes are configured to access and use at least a portion of the updated information stored in the at least one data cache to perform a service. In accordance with an embodiment, the computer-based service hosting platform may include at least one server computer. The constellation engine may include a web application configured to facilitate initial communication between a user kiosk device and the computer-based service hosting platform. The initial communication may provide for a user kiosk device to log into the computer-based service hosting platform, matching of a user kiosk device to a service, and configuration of a user kiosk device based on a matched service. The transport layer may be implemented, at least in part, using full-duplex communication channels over a single transmission control protocol (TCP) connection. The constellation engine may be configured to transparently scale a service provided by a service node to additional user kiosk devices as the additional user kiosk devices access the computer-based service hosting platform and are matched to the service.

In one embodiment, a system is provided that includes the computer-based service hosting platform as described above, one or more data sources, and at least one database computer configured to receive and store information from the one or more data sources. The system also provides a data communication infrastructure and one or more user kiosk devices configured to communicate with one or more of the service nodes over the transport layer of the computer-based service hosting platform through the data communication infrastructure. The data communication infrastructure may include one or more of the internet, a cellular telephone network, a satellite communication network, a wide-area-network (WAN), and a local area network (LAN), for example. The at least one database computer may be further configured to maintain a list of user kiosk devices, configurations, and security levels. The computer-based service hosting platform is configured to pull information from the one or more user kiosk devices and push service information to the one or more user kiosk devices via at least one service node over the transport layer as part of a service provided by the computer-based service hosting platform. The one or more user kiosk devices may be configured to receive sensor data from one or more sensors associated with the one or more user kiosk devices. The one or more user kiosk devices may be configured to display service information, provided by the computer-based service hosting platform via at least one service node, in accordance with a configuration of the one or more user kiosk devices as configured through the computer-based service hosting platform. The computer-based service hosting platform may be configured to associate the one or more user kiosk devices with each other based on a common service provided to the one or more user kiosk devices by the computer-based service hosting platform through at least one service node. The one or more user kiosk devices may include one of a mobile smart phone device, a smart television device, a tablet computer device, or a personal computer device.

In one embodiment, a method is provided. The method includes transferring information between a plurality of associated user kiosk devices through the system described above herein in accordance with a service provided by the computer-based service hosting platform. The method also includes displaying at least a portion of the information on the plurality of user kiosk devices in accordance with a configuration of each of the plurality of user kiosk devices. The method may further include detecting and reporting three-dimensional movements of a first user of a first user kiosk device of the plurality of user kiosk devices to the computer-based service hosting platform. The method may include a service node of the computer-based service hosting platform performing a service action in response to the three-dimensional movements of the first user. The method may also include providing a result of the service action to at least a portion of the plurality of user kiosk devices, and displaying the result on at least a portion of the user kiosk devices. The method may further include a second user of a second user kiosk device of the plurality of user kiosk devices performing an action in response to the three-dimensional movements of the first user as provided to the second user kiosk device by the computer-based service hosting platform. The method may include automatically displaying first configured information of a service provided by the computer-based service hosting platform on a first user kiosk device when a first user is in the vicinity of the first user kiosk device, and automatically displaying the first configured information on a second user kiosk device when the first user is in the vicinity of the second user kiosk device.

### BRIEF DESCRIPTION OF THE DRAWINGS

Reference is made to the accompanying drawings in which particular embodiments of the invention are illustrated as described in more detail in the description below, in which:

FIG. 1 is a schematic illustration of an exemplary embodiment of a system for providing services to a computerized grid of user kiosk devices;

FIG. 2 is a schematic illustration of an exemplary embodiment of a constellation engine of the system of FIG. 1;

FIG. 3 is a schematic illustration of an exemplary embodiment of a user kiosk device of the system of FIG. 1;

FIG. 4 is a schematic illustration of an exemplary embodiment of a first portion of a display configuration, for a user kiosk device, generated using the system of FIG. 1;

FIG. 5 is a schematic illustration of an exemplary embodiment of a second portion of a display configuration, for a user kiosk device, generated using the system of FIG. 1;

FIG. 6 is a schematic illustration of an exemplary embodiment of a third portion of a display configuration, for a user kiosk device, generated using the system of FIG. 1; and

FIG. 7 is a schematic illustration illustrating the concept of a user kiosk display configuration automatically following a user as the user moves from kiosk device to kiosk device.

### DETAILED DESCRIPTION

A group of users at different locations may desire to easily share service-related information with each other via respective user devices. The group of users may be part of a customer service team, a transportation management team, a delivery service team, a police department team, or some other type of team where it is desirable to share service-related information in real time. Furthermore, it may be desirable for each user to be able to customize the type of service-related information to receive and send from their user device, and how to display desired service-related information on their user device. Types of service-related information to share may include, for example, commands from a user, data from associated user equipment/vehicles in the field, geo-position data of users, or any other type of information that may help facilitate the accomplishment of a task or goal by providing one or more services to users.

Systems and methods providing real time services to users of associated kiosk device terminals (a service grid) in the form of service tracking and display functionality are provided. Embodiments of the invention allow a user to become associated with a group of other users via user kiosk devices that allow data and information to be readily shared in real time in accordance with each user's requirements. A computer-based service hosting platform provides a constellation engine that associates user kiosk devices with services provided in the form of software-based service nodes and allows the service nodes and the user kiosk devices to communicate directly over a transport layer implemented, at least in part, using full-duplex communication channels over a single transmission control protocol (TCP) connection. The associated user kiosk devices form a virtual service grid that is managed by the computer-based service hosting platform.

“Software” or “computer program” as used herein includes, but is not limited to, one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Computer” or “processing element” or “computer device” or “processor” as used herein includes, but is not limited to, any programmed or programmable electronic device that can store, retrieve, and process data. “Non-transitory computer-readable media” include, but are not limited to, a CD-ROM, a removable flash memory card, a hard disk drive, a magnetic tape, and a floppy disk. “Computer memory”, as used herein, refers to a storage device configured to store digital data or information which can be retrieved by a computer or processing element.

“Computer-based service hosting platform”, as used herein, refers to the computers, logic circuitry and/or processing elements and associated software or programs involved in providing services to a plurality of user kiosk devices. The terms “signal”, “data”, and “information” may be used interchangeably herein and may refer to digital or analog forms. The terms “communication device” as used herein may refer to any wired or wireless device (e.g., a computer modem) operable to receive and/or transmit signals, data, or information. The term “communication infrastructure” as used herein may refer to any or all of the systems involved in providing the communication of information between two or more devices (e.g., a cellular telephone system, the internet, a satellite communication system). The term “user interface” as used herein may refer to any and all types of hardware and/or software that allow a user to interact with a device (e.g., a keypad, a keyboard, a touch-screen, a computer mouse, a voice-activated system). The term “scanning device” as used herein may refer to a device configured to read encoded data (e.g., bar code data or RFID data) for use by a computer device. “RFID” refers to radio frequency identification.

The term “service node”, as used herein, may refer to software configured to operate as part of a computer-based service hosting platform to provide a service to one or more user kiosk devices or to one or more other service nodes. A service node may apply rules and logic for performing a service. The term “service node” may also refer to software and/or associated hardware configured to operate externally to a computer-based service hosting platform to provide a service under the control of the computer-based serviced hosting platform. The terms “data cache” and “data bucket” are used interchangeably herein and refer to the computer memory or computer storage associated with one or more service nodes within a computer-based service hosting platform. The terms “user kiosk device” and “user kiosk terminal” are used interchangeably herein and refer to a mobile or substantially fixed communication device of a user that has been configured to communicate and display service-related information using a computer-based service hosting platform. The term “sensor” is used broadly herein to refer to any device or combination of devices that are configured to capture and provide data associated with a sensed or monitored parameter to a user kiosk device. The term “smart” as used herein with respect to a device refers to a device having an operating system operating on a processor providing more advanced computing capability and connectivity than that of a feature device.

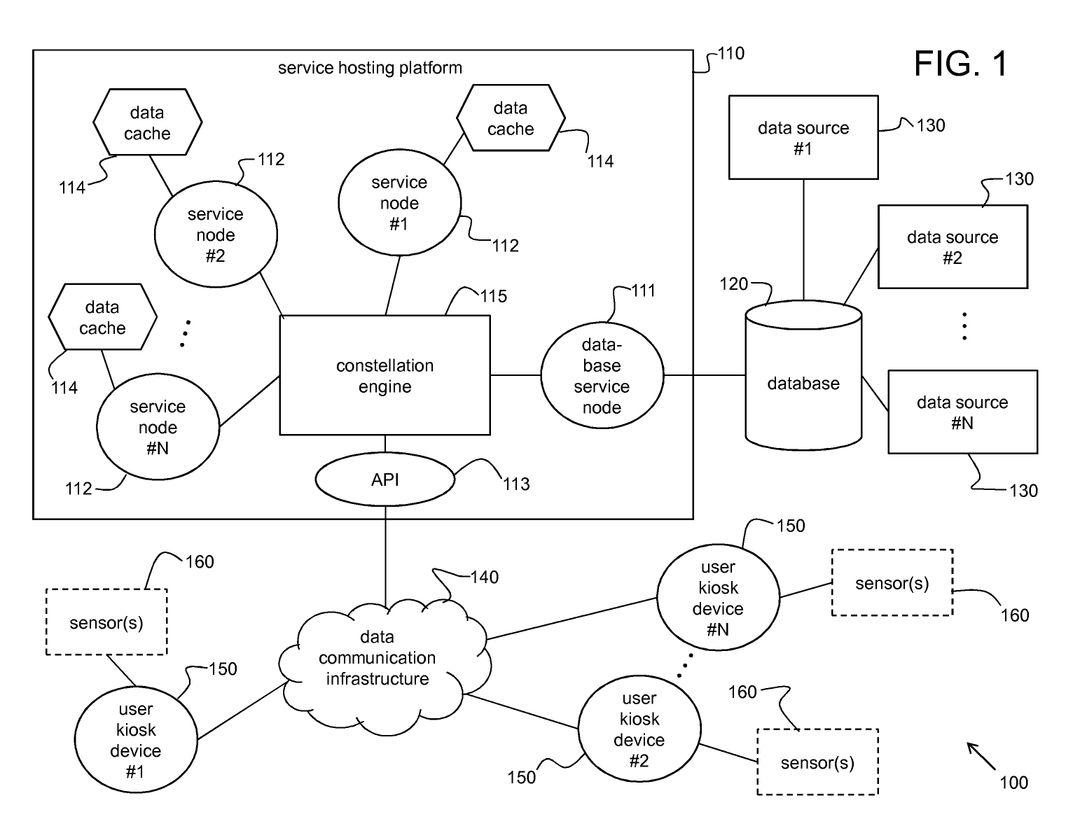

FIG. 1 is a schematic illustration of an exemplary embodiment of a system 100 for providing services to a virtual computerized grid of user kiosk devices. The system 100 includes a computer-based service hosting platform 110, a database 120, a plurality of data sources 130, a data communication infrastructure 140, and a plurality of user kiosk devices or terminals 150. A user kiosk device 150 may have one or more sensors 160 associated with it, in accordance with an embodiment.

The service hosting platform 110 includes software implemented on one or more server computers, for example, in accordance with an embodiment. The service hosting platform 110 includes a constellation engine 115, a database service node 111, and one or more other service nodes 112. The other service nodes 112 may each have a data cache (data bucket) 114 associated with it, in accordance with an embodiment. A data cache 114 stores small amounts of data associated with one or more service nodes 112. The data stored in a data cache 114 may originate from the database 120 or from one or more of the user kiosk devices 150. The service hosting platform 110 also includes an application programming interface (API) 113 for communicating with user kiosk devices 150 through the data communication infrastructure 140.

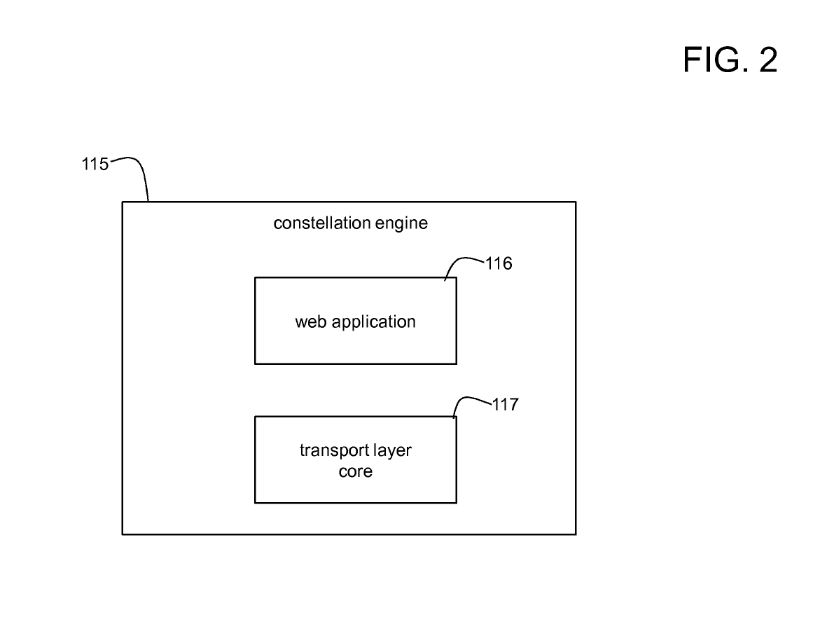

The constellation engine 115 generates and provides the service nodes 112 which are software based. The service nodes 112 operate on the constellation engine to provide one or more services that are accessible by the external user kiosk devices 150 via the API 113 through the data communication infrastructure 140. FIG. 2 is a schematic illustration of an exemplary embodiment of a constellation engine 115 of the system 100 of FIG. 1. The constellation engine includes a web application 116 and a transport layer core 117.

The web application 116 is configured to facilitate initial communication between a user kiosk device 150 and the service hosting platform 110. The initial communication provides for facilitating a user kiosk device 150 to login to the service hosting platform 110, match a user kiosk device 150 to a service, and configure a user kiosk device 150 based on one or more matched services. In accordance with an embodiment, the service hosting platform 110 may try to match a user kiosk device to a service based on characteristics of the user kiosk device provided to the service hosting platform during initial communication with the service hosting platform via the web application 116. Characteristics of the user kiosk device may include, for example, that the device is a mobile device and that the device has GPS capability. Other characteristics are possible as well, in accordance with other various embodiments.

A user kiosk device may be configured by having a user of the user kiosk device interact with a web site provided by the web application 116, or by downloading a configuration application to the user kiosk device and having the user interact with the configuration application on the user kiosk device. In accordance with another embodiment, a user kiosk device may be configured by “boot-loading” the user kiosk device. As an example, boot-loading the user kiosk device may involve plugging a universal serial bus (USB) flash drive into a port of the user kiosk device. The information on the USB flash drive may facilitate communication with the web site provided by the web application 116, or may provide automatic configuration of the user kiosk device with minimal or no user interaction.

Once a user kiosk device goes through the initial communication process and is matched to a service, the user kiosk device may then communicate via the transport layer 117. The transport layer 117 is implemented, at least in part, using full-duplex communication channels over a single transmission control protocol (TCP) connection and is configured to facilitate more direct, real time communication between user kiosk devices 150 via service nodes 112 and more direct, real time communication between service nodes 112, instead of having to communicate more indirectly and slowly through the web application 116. In accordance with an embodiment, the constellation engine 115 is configured to transparently scale a service provided by a service node to additional user kiosk devices 150 as the additional user kiosk devices access the service hosting platform 110 and are matched to the service. In this manner, a service grid of user kiosk devices can grow and still be accommodated by the service hosting platform 110.

In accordance with an embodiment, a kiosk device 150 may be configured by the service hosting platform 110 as an external service node. Such an external service node may be configured to operate externally to the computer-based service hosting platform 110 to provide a service under the control of the computer-based serviced hosting platform 110. For example, in one embodiment, an external service node may include a camera monitoring device and associated service software providing a security monitoring service for a business. In another embodiment, an external service node may include a hydraulic actuator and associated service software providing an access service for access to a transportation station of a transportation facility.

The database service node 111 of the service hosting platform 110 is configured to “sip” or acquire small pieces of data from the database 120 as data in the database is updated. That is, only data that changes in the database 120 is acquired by the database service node 111 of the service hosting platform 110. Upon acquiring an updated piece of data, the constellation engine 115 takes the updated piece of data from the database service node 111 and stores the updated piece of data in the appropriate data cache 114 of a corresponding service node 112 associated with the updated piece of data. In this manner, service nodes 112 are efficiently provided with pieces of updated information over time, without the service hosting platform 110 having to perform a massive download of data from the database 120 in a relatively short period of time. As a result, a graceful, low bandwidth updating of the data associated with the services of the service hosting platform 110 is accomplished.

The data communication infrastructure 140 may include one or more of, for example, the internet, a cellular telephone network, a satellite communication network, a wide area network (WAN), or a local area network (LAN) and may facilitate wired and/or wireless communication. The user kiosk devices 150 may include, for example, one or more of mobile “smart” phone devices, tablet computer devices, personal computer devices, “smart” television devices, or other processor-based communication devices having, for example, a display screen.

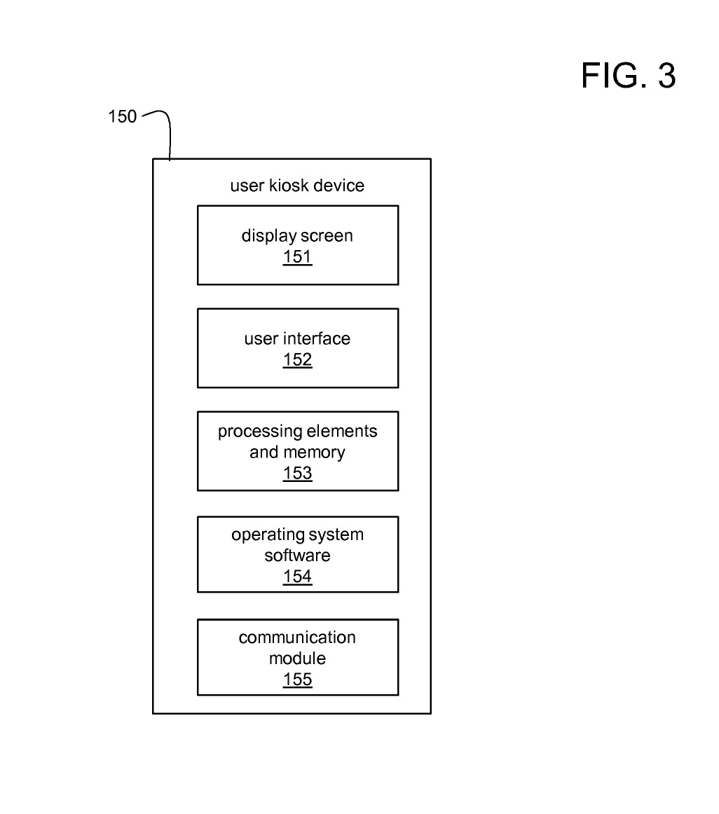

FIG. 3 is a schematic illustration of an exemplary embodiment of a user kiosk device 150 of the system 100 of FIG. 1. The user kiosk device 150 may include a display screen 151, a user interface 152, processing elements and memory 153, operating system software 154, and a communication module 155. In accordance with one embodiment, the display screen 151 may include user interface features, for example, when the display screen 151 is a touch-screen display. The communication module 155 provides wired or wireless communications with the service hosting platform 110 via the data communication infrastructure 140. The user interface 152 may be, for example, a keypad, a keyboard, a touch-screen interface, a computer mouse, or any of a number of other types of user interfaces as are known in the art.

The database 120 includes a database computer, in accordance with an embodiment, with associated database software and is configured to maintain a list of user kiosk devices, configurations, and security levels, and receive and store information from the data sources 130. A data source 130 may be any of a number of types of sources of data including, for example, an enterprise resource planning (ERP) system, a transportation management system (TMS), an accounting system, another database, or any source of data that may provide useful information for use by a service provided by the service hosting platform 110.

A sensor 160, associated with a user kiosk device 150, may include, for example, a global positioning system (GPS) receiver, a data system and a vehicle data interface device, or an environmental monitoring device. Other types of sensors may be employed as well such as, for example, shock and vibration sensors or accelerometers. For example, a GPS receiver may be installed on a vehicle to provide a current location of the vehicle to a user kiosk device also installed on or associated with the vehicle. A vehicle data interface device may be installed on a vehicle to provide monitored vehicle data (e.g., vehicle speed, vehicle oil pressure, etc.) to a user kiosk device also installed on or associated with the vehicle, for example, as captured by a data system of the vehicle. Data related to other types of vehicle parameters may be captured and received as well by the data system and the vehicle data interface device, in accordance with various embodiments.

An environmental monitoring device (e.g., a temperature sensor or a humidity sensor) may monitor the temperature and/or the humidity of an environment inside a vehicle transporting a product to be kept within determined temperature and humidity ranges and provide temperature and humidity data to a user kiosk device installed on or associated with the vehicle, for example. Communication between a sensor 160 and a user kiosk device may be wired or wireless, in accordance with various embodiments.

A general overview of the operation of the system 100, in accordance with an embodiment, is now discussed in the context of an exemplary application being that of a transportation company. In accordance with the example, the computer-based service hosting platform 110 is a transportation management service platform at a facility of a transportation company. The database 120 and the data sources 130 are part of a transportation management system that facilitates the management of all the facilities and vehicles of the transportation company. The user kiosk devices 150 are mobile devices, each located in a transportation vehicle of a transportation fleet of the transportation management company. Each vehicle may have one or more sensors 160 configured to provide data to the associated user kiosk device. The data communication infrastructure 140 is a wireless cellular telephone and data network and the internet. The service hosting platform 110 is used to configure the user kiosk devices of the fleet of transportation vehicles into a service grid.

In accordance with the example embodiment, the service hosting platform (e.g., a transportation management service platform) 110 provides a first service node 112 providing a first service that tracks the geographic location of each of the user kiosk devices 150 in the respective vehicles and allows each user kiosk device to display a location of the other user kiosk devices 150 overlaid on a map on a display screen 151 of the user kiosk devices. Each user kiosk device is associated with a GPS receiver (sensor) such that each user kiosk device receives geographic location information from the associated GPS receiver, provides the geographic location information to the first service node 112 of the transportation management service platform 110 via the wireless cellular telephone and data network 140 over the transport layer 117. The first service node 112 provides map information and geographic location information over the transport layer via the wireless cellular telephone and data network 140 to all of the user kiosk devices 150 that are configured to receive such information. In this manner, the users of each user kiosk device 150 may view the location of the other user kiosk devices (and, therefore, other vehicles) on the display screen 151. The map information may be provided to the service hosting platform 110 from a data source 130 via the database 120, for example.

Furthermore, in accordance with the example embodiment, the service hosting platform (transportation management service platform) 110 provides a second service node 112 providing a second service that monitors the fuel level in each of the transportation vehicles having a user kiosk device 150. The fuel levels of each of the transportation vehicles are provided to the respective user kiosk devices via a vehicle data interface device of the vehicle and provided to the second service node 112 of the transportation management service platform 110. The second service node 112 processes the fuel levels of the vehicles and determines if the vehicles have enough fuel to complete their respective transportation missions without having to re-fuel. The second service node 112 may send an alert message to a user kiosk device of a vehicle if the vehicle will likely need to stop to re-fuel before completing its transportation mission. Again, communication of the fuel levels and alerts is performed expeditiously over the transport layer 117 in real time.

Also, in accordance with the example embodiment, the service hosting platform (transportation management service platform) 110 provides a third service node 112 providing a third service that estimates a time of arrival of a vehicle at its destination by gathering travel speed information from a user kiosk device associated with the vehicle and using the geographic location information from the first service node and mission route information for the vehicle obtained from the database 120 of the transportation management system. The speed information of the vehicle may be obtained by the user kiosk device associated with the vehicle through a vehicle data interface device of the vehicle, for example. The third service node 112 may share the estimated time of arrival information with other user kiosk devices 150. For example, the times of arrival may be estimated by the third service node 112 for all of the vehicles in a transportation fleet and provided to a user kiosk device 150 at a central dispatch facility of the transportation company. In this manner, a dispatch manager (user) can monitor the estimated times of arrival and become aware of any delays. Again, communication of the estimated times of arrival is performed expeditiously over the transport layer 117 in real time.

In accordance with an embodiment, each user kiosk device may be configured in a customized manner to take advantage of one or more services as desired by the user (or as required by the user's superiors). For example, referring to the transportation company example discussed above, a user of a first user kiosk device may configure the first user kiosk device to acquire and display fuel level alerts for his vehicle and other vehicles in a first transportation convoy. A user of a second user kiosk device may configure the second user kiosk device to acquire and display speed information for his vehicle and other vehicles in a second transportation convoy, along with an estimated time of arrival for his vehicle. Such configurations may be set up via the web application 116 of the constellation engine 115.

Also, in accordance with the example embodiment, the service hosting platform 110 may provide a fourth service node 112 providing a fourth service that allows a user of a first user kiosk device to switch from displaying a first configured view of the first user kiosk device to displaying a second configured view of a second user kiosk device. For example, a transportation dispatcher may be able to selectively view, on his user kiosk device, that which is being displayed on another user kiosk device in the field. In this manner the transportation dispatcher may be able to switch from one user kiosk device in the field to another, successively viewing that which is displayed on each user kiosk device in the field.

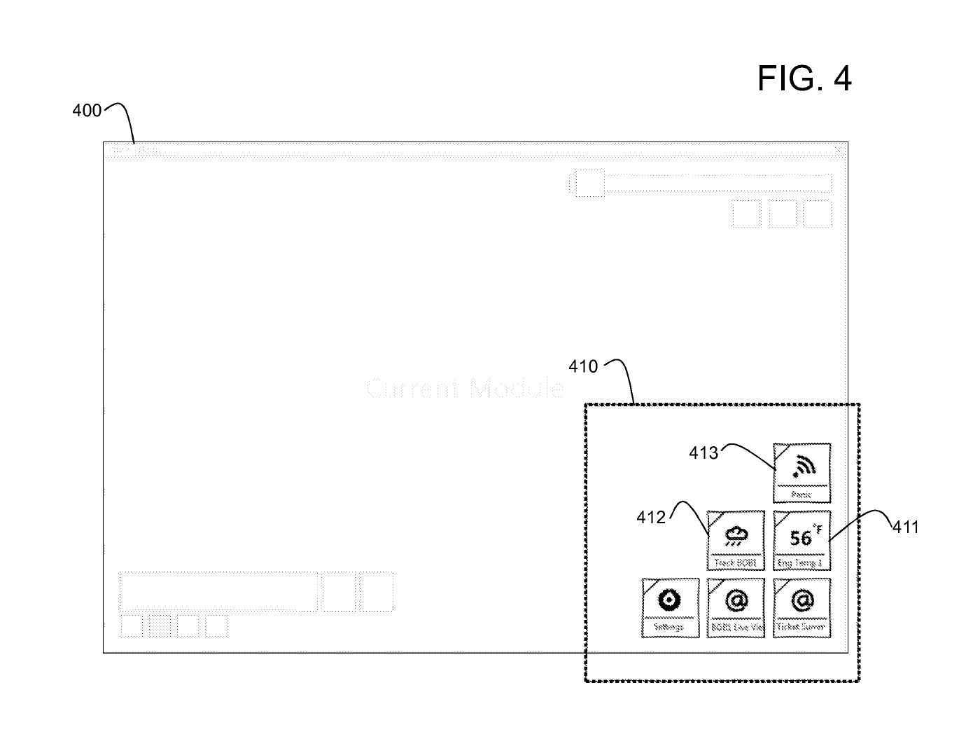

FIG. 4 is a schematic illustration of an exemplary embodiment hi-lighting a first portion 410 of a display configuration 400, for a user kiosk device 150, generated using the system 100 of FIG. 1. The first portion 410 shows a cluster of icons where each displayed icon corresponds to one or more services provided by a service hosting platform 110. The cluster of icons 410 may correspond to those services most important to the user. One icon 411 shows the engine temperature of a first vehicle. Another icon 412 shows an indication of the weather in the vicinity of a second vehicle. Another icon 413 shows a panic button that may be selected by the user of the user kiosk device to alert other users on his grid that he is having some kind of problem that may require immediate assistance. The panic button icon 413 is an example of how a user may send selective alerts or commands to other users of the service grid.

Furthermore, a user kiosk device 150 may be configured to allow a user to quickly “fling” information to another user kiosk device. For example, a user of a first user kiosk device may place his finger on an icon in the cluster of icons and drag the icon to a portion of the display configuration designated for a second user kiosk device. As a result, the first user may command that the information provided by the dragged icon be provided and displayed to the user of the second user kiosk device. For example, if the first user is monitoring the weather in the vicinity of a remotely located vehicle via the icon 412, the user may drag the icon 412 to the portion of the display configuration designated for the second user, indicating that the second user is now responsible for monitoring the weather in the vicinity of the remotely located vehicle. A separate service node 112, providing the service of allowing one user to “fling” information to another user, may be provided by the service hosting platform 110.

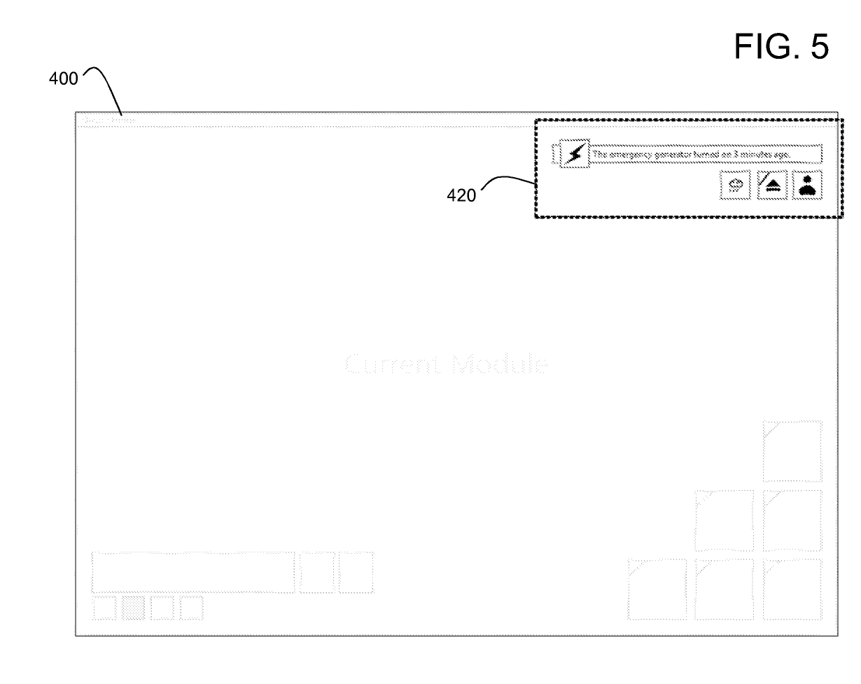

FIG. 5 is a schematic illustration of an exemplary embodiment hi-lighting a second portion 420 of the display configuration 400, for a user kiosk device 150, generated using the system 100 of FIG. 1. The second portion 420 is a heads-up space of the display configuration. The heads-up space 420 may be used to display very important or critical information to a user. In this example, the heads-up space 420 is displaying a message that an emergency generator turned on three minutes ago. The emergency generator may be an element of a destination facility that a vehicle associated with the user kiosk device 150 displaying the message is headed towards, for example.

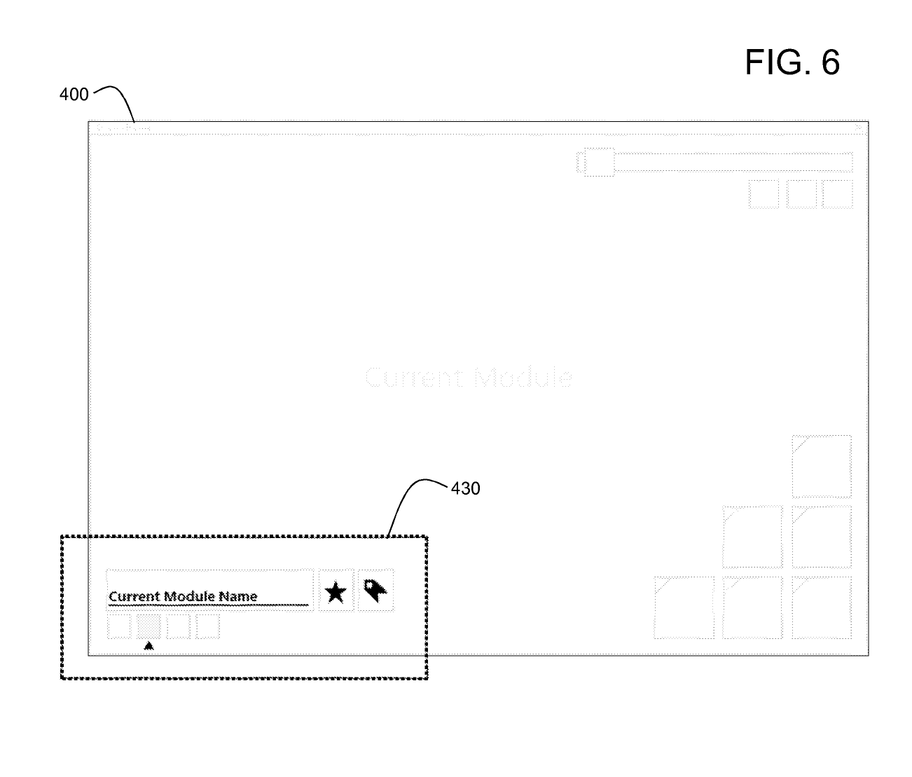

FIG. 6 is a schematic illustration of an exemplary embodiment hi-lighting a third portion 430 of the display configuration 400, for a user kiosk device 150, generated using the system 100 of FIG. 1. The third portion 430 corresponds to a module selection section that allows a user to select one of a plurality of service modules where a service module corresponds to a defined set of services. When a service module is selected by the user, the name of the selected module is displayed in the third portion, the corresponding service icons are displayed in the first portion 410, and corresponding heads-up information is displayed in the second portion 420. In this manner, a user may switch between several defined service configurations using the user kiosk device 150.

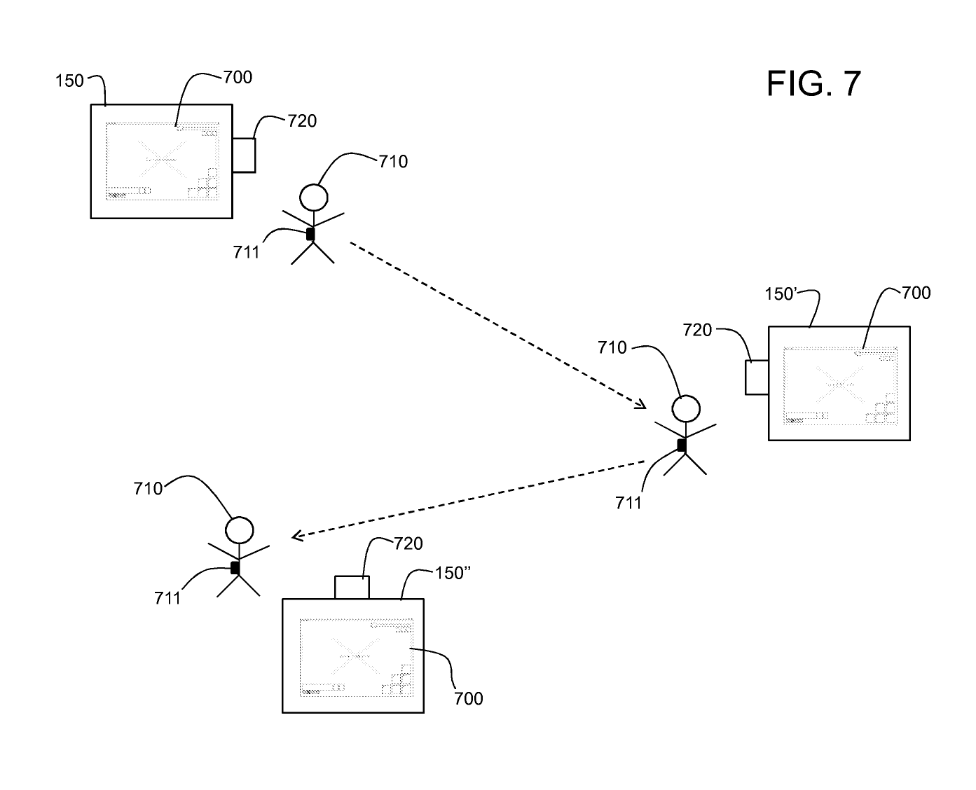

FIG. 7 is a schematic illustration showing the concept of a user kiosk display configuration 700 automatically following a user 710 as the user moves from kiosk device to kiosk device at different locations (e.g., from 150 to 150′ to 150″ as shown in FIG. 7). In accordance with an embodiment, each user kiosk device 150 has a user identifying device 720. A user identifying device 720 is configured to identify a user 710 as the user 710 approaches the associated kiosk device 150. A user identifying device 720 may be, for example, one of a facial recognition system, a radio frequency identification (RFID) system, a badge or card reading system, or a bar code reading system. Other types of user identifying devices are possible as well, in accordance with other embodiments of the present invention.

In some embodiments, the user may wear a scannable device 711 such as, for example, an RFID tag, a bar coded badge, or a magnetic strip card. Other types of scannable devices are possible as well, in accordance with other embodiments of the present invention. If the user identifying device 720 includes a RFID scanner, then the scannable device 711 may be an RFID tag. If the user identifying device 720 includes a bar code reader, then the scannable device 711 may be a bar coded badge.

As a user moves from kiosk device to kiosk device, the user is identified by each kiosk device via the associated user identifying device 720. Once the user is identified by a kiosk device, the system 100 “knows” to display the user's display configuration 700 on a display screen of that user kiosk device. In this manner, a user may move from kiosk device to kiosk device and be able to always view his display configuration 700 corresponding to one or more services provided by the service hosting platform 110. Such an embodiment may be very useful in a manufacturing environment, where a supervising user has to move about a large factory floor as part of his job.

In accordance with an embodiment, a user kiosk device 150 may be configured to detect and report three-dimensional movements or gestures of a user to the service hosting platform 110. For example, the user kiosk device may be configured with the Microsoft Kinect™ motion sensing input device to detect three-dimensional movements of a user. The three-dimensional movements may be reported as command data to the service hosting platform 110 and interpreted by a service node 112 as a command, for example. The service node may perform a service action in response to the command data, in accordance with an embodiment, and provide a result of the service action to one or more user kiosk devices on a service grid where the result may be displayed to the users. Alternatively, the three-dimensional movements may be reported as data to one or more other user kiosk devices on a service grid, via a service node, and displayed to the users. A user may then proceed to perform an action in response to observing the displayed data corresponding to the three-dimensional movements.

In summary, systems and methods providing real time services to users of associated kiosk device terminals in the form of service tracking and display functionality are provided. Embodiments of the invention allow a user to become associated with a group of other users via user kiosk devices that allow data and information to be readily shared in real time in accordance with each user's requirements. A computer-based service hosting platform provides a constellation engine that associates user kiosk devices with services provided in the form of software-based service nodes and allows the service nodes and the user kiosk devices to communicate directly over a transport layer implemented, at least in part, using full-duplex communication channels over a single transmission control protocol (TCP) connection.

With reference to the drawings, like reference numerals designate identical or corresponding parts throughout the several views. However, the inclusion of like elements in different views does not mean a given embodiment necessarily includes such elements or that all embodiments of the invention include such elements.

In the specification and claims, reference will be made to a number of terms have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be”.

The terms “including” and “having” are used as the plain language equivalents of the term “comprising”; the term “in which” is equivalent to “wherein.” Moreover, the terms “first,” “second,” “third,” “upper,” “lower,” “bottom,” “top,” etc. are used merely as labels, and are not intended to impose numerical or positional requirements on their objects. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

This written description uses examples to disclose the invention, including the best mode, and also to enable one of ordinary skill in the art to practice the invention, including making and using any devices or systems and performing any incorporated methods. The embodiments described herein are examples of articles, systems, and methods having elements corresponding to the elements of the invention recited in the claims. This written description may enable those of ordinary skill in the art to make and use embodiments having alternative elements that likewise correspond to the elements of the invention recited in the claims. The scope of the invention thus includes articles, systems and methods that do not differ from the literal language of the claims, and further includes other articles, systems and methods with insubstantial differences from the literal language of the claims. While only certain features and embodiments have been illustrated and described herein, many modifications and changes may occur to one of ordinary skill in the relevant art.

What is claimed is:

1. A computer-based service hosting platform comprising:
a constellation engine configured to:
provide software-based service nodes, that provide one or more services, to operate on the constellation engine and which are accessible by external user kiosk devices, and
route information directly between the service nodes over a transport layer of the constellation engine;
a database service node configured to operate on the constellation engine to retrieve information from at least one database computer when the information changes in the at least one database computer; and
at least one data cache associated with at least one service node and configured to store updated information derived from one or more of the at least one database computer via the database service node or external user kiosk devices, wherein the service nodes are configured to access and use at least a portion of the updated information stored in the at least one data cache to perform a service.

2. The computer-based service hosting platform of claim 1, wherein the computer-based service hosting platform includes at least one server computer.

3. The computer-based service hosting platform of claim 1, wherein the constellation engine includes a web application configured to facilitate initial communication between a user kiosk device and the computer-based service hosting platform.

4. The computer-based service hosting platform of claim 3, wherein the initial communication provides for:
a user kiosk device to log into the computer-based service hosting platform;
matching of a user kiosk device to a service; and
configuration of a user kiosk device based on a matched service.

5. The computer-based service hosting platform of claim 1, wherein the transport layer is implemented, at least in part, using full-duplex communication channels over a single transmission control protocol (TCP) connection.

6. The computer-based service hosting platform of claim 1, wherein the constellation engine is configured to transparently scale a service provided by a service node to additional user kiosk devices as the additional user kiosk devices access the computer-based service hosting platform and are matched to the service.

7. A system comprising:
the computer-based service hosting platform of claim 1;
one or more data sources;
at least one database computer configured to receive and store information from the one or more data sources;
a data communication infrastructure; and
one or more user kiosk devices configured to communicate with one or more of the service nodes over the transport layer of the computer-based service hosting platform through the data communication infrastructure.

8. The system of claim 7, wherein the data communication infrastructure includes one or more of the internet, a cellular telephone network, a satellite communication network, a wide-area-network (WAN), and a local area network (LAN).

9. The system of claim 7, wherein the at least one database computer is further configured to maintain a list of user kiosk devices, configurations, and security levels.

10. The system of claim 7, wherein the computer-based service hosting platform is configured to pull information from the one or more user kiosk devices and push service information to the one or more user kiosk devices via at least one service node over the transport layer as part of a service provided by the computer-based service hosting platform.

11. The system of claim 10, wherein the one or more user kiosk devices are configured to receive sensor data from one or more sensors associated with the one or more user kiosk devices.

12. The system of claim 10, wherein the one or more user kiosk devices are configured to display service information, provided by the computer-based service hosting platform via at least one service node, in accordance with a configuration of the one or more user kiosk devices as configured through the computer-based service hosting platform.

13. The system of claim 7, wherein the computer-based service hosting platform is configured to associate the one or more user kiosk devices with each other based on a common service provided to the one or more user kiosk devices by the computer-based service hosting platform through at least one service node.

14. The system of claim 7, wherein the one or more user kiosk devices includes one of a mobile smart phone device, a smart television device, a tablet computer device, or a personal computer device.

15. A method of communication between user kiosk devices, the method comprising:
transferring information between a plurality of associated user kiosk devices through the system of claim 7 in accordance with a service provided by the computer-based service hosting platform; and
displaying at least a portion of the information on the plurality of user kiosk devices in accordance with a configuration of each of the plurality of user kiosk devices.

16. The method of claim 15, further comprising detecting and reporting three-dimensional movements of a first user of a first user kiosk device of the plurality of user kiosk devices to the computer-based service hosting platform.

17. The method of claim 16, further comprising a service node of the computer-based service hosting platform performing a service action in response to the three-dimensional movements of the first user.

18. The method of claim 17, further comprising providing a result of the service action to at least a portion of the plurality of user kiosk devices, and displaying the result on at least a portion of the user kiosk devices.

19. The method of claim 16, further comprising a second user of a second user kiosk device of the plurality of user kiosk devices performing an action in response to the three-dimensional movements of the first user as provided to the second user kiosk device by the computer-based service hosting platform.

20. The method of claim 15, further comprising:
automatically displaying first configured information of a service provided by the computer-based service hosting platform on a first user kiosk device when a first user is in the vicinity of the first user kiosk device; and
automatically displaying the first configured information on a second user kiosk device when the first user is in the vicinity of the second user kiosk device.
